(19) United States
(12) Patent Application Publication
(10) Pub. No.: US 2008/0011177 A1
(43) Pub. Date: Jan. 17, 2008

(54) Method of Printing Curved Surface and Curved Surface Body Printed by Using Same

(75) Inventor: Kouji Muraoka, Fukui (JP)

Correspondence Address: LADAS & PARRY, 26 WEST 61ST STREET, NEW YORK, NY, 10023, US

(73) Assignee: SHUHOU CO., LTD., Fukui (JP)

(21) Appl. No.: 11/631,771

(22) PCT Filed: Aug. 1, 2005
(86) PCT No.: PCT/JP05/14048

§ 371 Date: Jul. 24, 2007

(30) Foreign Application Priority Data
Aug. 4, 2004 (JP) 2004-227478
Sep. 6, 2004 (JP) 2004-258811

(51) Int. Cl. B41F 17/30

(52) U.S. Cl. 101/492

(57) ABSTRACT

A curved surface printing method comprises a step of applying a printing ink to a raised portion of a letterpress printing original plate which is a planographic plate the raised portion of which is 0.1 to 50 μm high, a step in which an elastic blanket (2) of rubber or rubberish material having a curved surface (221, 222, 21) of a predetermined shape formed on a convex or concave surface of an object (1) to be printed and set in the same polarity direction as that of the convex or concave surface of the object (1) is pressed to the letterpress printing original plate placed in a fixed position and coated with the printing ink, and the printing ink is transferred to the curved surface (221, 222, 21) of the predetermined shape, and a step of moving the elastic blanket (2) to which the printing ink is transferred and which has curved surface (221, 222, 21) of the predetermined shape, bringing the elastic blanket (2) into contact with the curved surface of the object (1), and thus printing the object. A curved surface body printed by this method is also disclosed.

### TECHNICAL FIELD

The present invention relates to a method of accurately printing on a to-be-printed object having a curved surface, and a curved surface body printed by using the method.

### BACKGROUND ART

In the background art, a printing method using a blanket is known well as a method of performing various kinds of printing on a curved surface of a to-be-printed object having curved surfaces, particularly a simple curved surface. That is, a background-art blanket printing method performs printing as follows. Ink is applied onto an intaglio printing original plate made of steel or plastic. Excessive ink is removed from a raised portion by a spatulate scraper. The surface of a soft curved blanket is pressed onto the printing original plate so that the ink left in a sunken portion of a conductor of the printing original plate is transferred to the blanket. This blanket is brought into contact with the curved surface of the to-be-printed object.

In this case, however, the printing original plate is made of steel or plastic in the background art. In order to scrape and remove the excessive ink from the raised portion after the ink is applied, the ink in the sunken portion has to be retained surely. In addition, in order to transfer the ink to the blanket satisfactorily, the depth of the sunken portion has to be made large enough. This also results in deteriorating the printing accuracy.

When the printing original plate has a large difference between the raised portion and the sunken portion, the surface of the blanket is deformed so largely that printing cannot be performed accurately by the blanket. In addition, particularly since the plate is an intaglio plate, the depth of the sunken portion has to be made large enough to retain the volume of the ink surely. When the depth is large, the blanket is also deformed largely. Further, due to the sunken portion, the blanket itself has to be soft enough to transfer the ink in the bottom portion of the sunken portion to the blanket and to be adapted to the difference between the raised portion and the sunken portion. Thus, the conditions become worse.

With respect to that point, when the printing original plate is a letterpress plate, it will go well if the ink is applied only to its raised portion. Alternatively, the raised portion may be made of the ink itself. The difference between the raised portion and the sunken portion can be reduced. As a result, a slightly hard blanket can be used as the blanket itself. In addition, since the difference between the raised portion and the sunken portion can be reduced, the deformation of the blanket surface can be reduced, and the volume of the ink can be also adjusted finely. Thus, accurate printing can be performed.

In the past, various techniques have been already developed about this system for printing on a curved surface using a letterpress plate and a blanket. For example, one of them is disclosed in Japanese Patent No. 2961153 (Japanese Patent Application No. Hei-01-059697) applied by the present applicant. However, more accurate printing has been requested in this system. Through many experiments and researches, the present applicant obtained the present invention where various specifications to satisfy this request are set in proper conditions. That is, the present invention fundamentally relates to an improvement patent of this patent.

An aluminum plate for use in offset printing can be used as the letterpress printing original plate. The aluminum plate has a photosensitive agent adhering to the surface thereof. The aluminum plate has high accuracy and extremely small irregularities of the order of microns. Thus, the aluminum plate is suitable for multi-color printing. Since the aluminum plate keeps high accuracy even in color separation, it has been used broadly. In this case, not to say, another plate than the aluminum plate may be used if it has reduced irregularities and allows ink to spread thereon accurately.

### DISCLOSURE OF THE INVENTION

### Problems that the Invention is to Solve

In the background art, as described above, when printing is performed upon a to-be-printed object having a curved surface, particularly a simple curved surface, the printing is performed by the combination of a curved surface printing blanket and an intaglio printing original plate. Therefore, the printing accuracy deteriorates, and multi-color printing is difficult. Particularly in the case of the intaglio plate, the volume of ink is so large that there is a disadvantage that the printing accuracy deteriorates extremely in fine dots or the like.

Further, almost all conditions about the shape and properties of the blanket have been set experientially by trial and error, and much time and much labor have been spent for the setting of the conditions. The setting of conditions includes setting of a shape with flexibility high enough to fit to the to-be-printed curved surface, setting of a material or a surface state desired in terms of retentivity and releasability with respect to printing ink, etc. As a result, the setting of conditions also includes setting of conditions such as desired fidelity of printing.

In consideration of the aforementioned situation, the present invention is aimed at proposing a method for easily setting conditions to allow curved surface printing to be performed upon a to-be-printed body having an R-curved surface in conditions that the printing accuracy is higher, and a curved surface body printed with improved fidelity by using the method.

A method of printing on a curved surface according to the present invention includes:

1) a method including the steps of: applying printing ink to a raised portion of a letterpress printing original plate which is a flat plate having the raised portion 0.1-50 μm high in height; pressing a rubber or rubbery elastic blanket, which has a curved surface with a predetermined shape set correspondingly to a convex curved surface or a concave curved surface of a to-be-printed object so as to have the same polarity direction as the convex curved surface or the concave curved surface of the to-be-printed object, onto the letterpress printing original plate disposed at a fixed position and supplied with the printing ink, so as to transfer the printing ink to the predetermined-shape curved surface; and moving the elastic blanket having the predetermined-shape curved surface with the printing ink transferred thereto, and bringing the elastic blanket into contact onto the curved surface of the to-be-printed object so as to perform printing thereon;

2) the method according to the aforementioned method 1), wherein the height of the raised portion of the letterpress printing original plate is set to be 0.1-25 μm;

3) the method according to the aforementioned method 1), wherein the height of the raised portion of the letterpress printing original plate is set to be not smaller than 0.1 μm and smaller than 3 μm; and 4) a method including the steps of: applying ink to a raised portion of a letterpress printing original plate which is a flat plate having a raised portion ½ to ⅓ as high as a thickness of a photosensitive agent in a usual letterpress printing original plate; pressing a rubber or rubbery elastic blanket, which has a curved surface with a predetermined shape set correspondingly to a convex curved surface or a concave curved surface of a to-be-printed object so as to have the same polarity direction as the convex curved surface or the concave curved surface of the to-be-printed object, onto the letterpress printing original plate disposed at a fixed position and supplied with the ink, so as to transfer the ink to the predetermined-shape curved surface; and moving the elastic blanket having the predetermined-shape curved surface with the ink transferred thereto, and bringing the elastic blanket into contact onto the curved surface of the to-be-printed object so as to perform printing thereon.

Further, the method of printing on a curved surface according to the present invention includes:

5) the method according to any one of the aforementioned methods 1) through 4), wherein the convex curved surface or the concave curved surface of the to-be-printed object is a simple arc curved surface having a curvature radius R;

6) the method according to any one of the aforementioned methods 1) through 5), wherein a principal axis section of the predetermined-shape curved surface is composed of two principal curved surfaces and an end portion curved surface smoothly connecting a portion where the two principal curved surfaces cross each other; the two principal curved surfaces have curvature radii R1 and R2 composing the predetermined-shape curved surface correspondingly to a curvature radius R of the principal axis section of the curved surface of the to-be-printed object; the curvature radii R1 and R2 are 4-8 times as large as the curvature radius R, and a value with which distances L from centers of the curvature radii R1 and R2 cross each other is 2-4 times as large as the curvature radius R; and the end portion curved surface has a curvature radius equivalent to the curvature radius of the to-be-printed object;

7) the method according to any one of the aforementioned methods 1) through 6), wherein a material of the elastic blanket is silicone rubber, and hardness (JIS A-scale) thereof is set to be 3-30; and

8) the method according to any one of the aforementioned methods 1) through 6), wherein a material of the elastic blanket is silicone rubber, and hardness (JIS A-scale) thereof is set to be 3-20.

Further, a method of printing on a curved surface according to the present invention includes:

9) the method according to any one of the aforementioned methods 1) through 8), wherein the printing ink has a viscosity of 5-500 PaS;

10) the method according to any one of the aforementioned methods 1) through 8), wherein the printing ink has a viscosity of 5-250 PaS;

11) the method according to any one of the aforementioned methods 1) through 8), wherein the printing ink has a viscosity 1⅕ times as high as a viscosity of a usual planographic-plate offset ink as practical measure; and

12) the method according to any one of the aforementioned methods 1) through 11), wherein surface roughness of the elastic blanket is set to be 0.5-2 μm in Hmax.

Further, a method of printing on a curved surface according to the present invention includes:

13) a method wherein the to-be-printed object has a shape including a partially convex curved surface portion or a partially concave curved surface portion in a flat portion; flat surface printing is applied to the flat portion by a usual printing method; and curved surface printing according to the method of printing on a curved surface according to any one of the aforementioned methods 1) through 12) is further applied to the partially convex curved surface portion or the partially concave curved surface portion.

A printed curved surface body according to the present invention includes:

14) a printed curved surface body having a surface printed by the method of printing on a curved surface according to any one of the aforementioned methods 1) through 13);

15) the printed curved surface body according to the aforementioned body 14), wherein the printed curved surface body is an automobile part;

16) the printed curved surface body according to the aforementioned body 14), wherein the printed curved surface body is a handle or an interior or exterior member for a car, 17) the printed curved surface body according to the aforementioned body 14), wherein the printed curved surface body is a body of a cellular phone or an electrical household appliance; 18) the printed curved surface body according to the aforementioned body 14), wherein the printed curved surface body is a sporting tool; 19) the printed curved surface body according to the aforementioned body 14), wherein the printed curved surface body is an ornament; and 20) the printed curved surface body according to the aforementioned body 19), wherein the printed curved surface body is an eyeglass frame in the ornament.

### EFFECT OF THE INVENTION

According to a method of printing on a curved surface according to the present invention, accurate printing on a curved surface and a curved surface body printed by using the printing can be provided comparatively inexpensively.

### BRIEF DESCRIPTION OF THE DRAWINGS

FIG. 1 are views for schematically explaining a blanket shape with respect to a sectional curvature radius R of a to-be-printed curved surface, wherein (a) shows a principal section of the to-be-printed curved surface body, and (b) shows a sectional shape of the blanket corresponding thereto.

FIG. 2 is a graph showing an example of the relationship between a principal curvature radius R1, R2 and a center moving distance X according to the present invention.

FIG. 3 is a table showing results of tests for comparison between the surface roughness of a curved surface printing blanket according to the present invention and the degree of spread of printing ink.

FIG. 4 is a graph showing results of testing the relationship between the height of a raised portion of a printing original plate (depth of a sunken portion in the curve C) according to the invention and printing accuracy.

FIG. 5 is a graph showing results of testing the relationship between blanket hardness H and printing accuracy.

### BEST MODE FOR CARRYING OUT THE INVENTION

The present invention is characterized in that the manufacturing specifications of a curved surface printing blanket, which have heretofore depended on feeling and experience, can be simplified and determined easily. The present invention is also characterized in that printing on a curved surface with high printing accuracy can be obtained by a combination of an appropriate curved surface printing blanket based on determined specifications and a special letterpress original plate. The present invention is further characterized by providing a printed curved surface body, particularly a handle or an interior or exterior member for a car, which can be obtained comparatively inexpensively by the curved surface printing method.

That is, preferred specifications of the curved surface printing blanket and the letterpress printing original plate are specified in the following aspects.

1) A blanket shape and a blanket material (particularly hardness and elastic modulus) corresponding to the shape of a to-be-printed object, particularly an arc shape composed of a curvature radius R.

2) Blanket surface properties (ink spreadability and releasability) with which printing ink on the original plate is transferred to the blanket surface efficiently and the ink is printed on the to-be-printed body efficiently.

3) Setting of proper height accuracy of the raised portion of the printing original plate.

Silicone rubber is chiefly used as the material of the curved surface printing blanket. The curved surface printing blanket is required to have surface properties including ink absorbability with which ink can be transferred from the letterpress original plate to the blanket surface, a property with which a solvent component of the ink can be absorbed to increase the ink viscosity, releasability with which the ink can be transferred perfectly to the surface of the to-be-printed curved surface, and a property with which the ink can be prevented from surviving in the blanket surface after being printed on the to-be-printed curved surface.

These properties are closely related to the performance of printing ink to be used. In view from the curved surface printing blanket, the properties depend on the surface free energy of the blanket surface itself. The properties highly depend on the material of the blanket and the form of the blanket surface, particularly the surface roughness thereof.

That is, the absorbability with which ink can be transferred from the letterpress original plate to the blanket surface, the releasability with which the ink can be transferred perfectly to the to-be-printed curved surface or the property with which the ink can be prevented from surviving in the blanket surface after being printed on the to-be-printed curved surface are antithetical properties. It is difficult to allow the blanket material itself to change its properties as to these properties in a short time during a printing process.

The present applicant conducted many experiments and obtained knowledge as follows. In a real operation process of the curved surface printing blanket according to the present invention, that is, in a combination of a step (A) of transferring ink from the letterpress original plate to the curved blanket (wherein the blanket surface displaces from a curved surface to a flat surface), a step (B) of moving the blanket to the position of the to-be-printed body (wherein the blanket surface displaces from the flat surface to a curved surface) and a step (C) of pressing the blanket onto the to-be-printed body so as to perform printing on the curved surface (wherein the blanket surface displaces from a positive-polarity curved surface to a negative-polarity curved surface), the ink retentivity of the curved blanket surface can comparatively change and follow the aforementioned antithetical properties in a range of roughness.

As a result of comparison tests which will be described later, the blanket will cause a problem if its surface roughness is too fine or too rough. When the blanket is fine in surface roughness, the blanket has comparatively high retentivity but a defect in releasability. When the blanket is too rough, the retentivity deteriorates but the releasability is comparatively high. Particularly in a range of 0.5-2 μm, both the retentivity and the releasability are satisfactory. It is preferable that the surface roughness of the printing curved blanket according to the present invention is set in the range of 0.5-2 μm.

In order to print on a curved surface with high accuracy, it is necessary to prepare a printing curved surface blanket having a blanket shape suitable to a to-be-printed curved surface body. As described previously, almost all of the specification conditions of this blanket have been set by empirical trial and error in the background art. Much time and labor have been spent for the setting. The present invention is to propose a system for comparatively easily setting a blanket shape corresponding to a shape of a to-be-printed object, particularly an arc shape composed of a curvature radius R.

The system was fundamentally based on Hertz Stress theory where two curved surfaces are brought into pressure contact, and was modified based on many experiments. Thus, a comparatively simple specification setting system was obtained.

FIG. 1 are views for schematically explaining the blanket shape corresponding to the sectional curvature radius R of the to-be-printed curved surface, wherein (a) shows a principal section of the to-be-printed curved surface body, and (b) shows a sectional shape of the blanket corresponding thereto.

In FIG. 1, the reference numeral 1 represents a to-be-printed curved surface body; 2, a blanket; 21, a portion rounded in a portion where the R1 and R2 curved surfaces meet each other; 221, a curved surface with a principal curvature radius R1; 222, a curved surface with a principal curvature radius R2; 23, a blanket base portion; R, a sectional curvature radius of the to-be-printed curved surface; R1 and R2, two principal curvature radii of the blanket; R0, a curvature radius of the rounded portion of the portion where the curved surfaces meet each other; X, a center moving distance (eccentric distance) of R1 and R2; and θ, an angle in a contact portion in Example 4.

The shape of the blanket 2 is chiefly composed of three components corresponding to the sectional curvature radius R.

That is, the components include curved surface portions 221 and 222 of the shape of the blanket 2 having two principal curvature radii R1 and R2 respectively using the sectional curvature radius R as parameter, a portion 21 rounded by an inscribed arc (about 25°) having a curvature radius R0 and inscribed in the portion where the curved surfaces meet each other, and a blanket base portion 23 to be used for elastically retaining the blanket 2 and mounting the blanket.

The two principal curvature radii R1 and R2 are designed to be decentered inward by the distance X so that the centers of the two principal curvature radii R1 and R2 cross each other. The principal curvature radii R1 and R2 are set at values sufficient to print half the largest circumference of the to-be-printed curved surface 1 having the sectional curvature radius R. The knowledge that the principal curvature radii R1 and R2 were desired to be 4-8 times, preferably 6-8 times as large as the sectional curvature radius R of the to-be-printed curved surface 1 was obtained. If the principal curvature radii R1 and R2 are smaller than 4 times as large as the sectional curvature radius R, the printing accuracy will deteriorate. If the principal curvature radii R1 and R2 are larger than 8 times as large as the sectional curvature radius R, the shape of the blanket itself will increase resulting in disadvantage in design and cost.

It is preferable that the moving distance X of the center is set in a range of 1-2 times as large as the sectional curvature radius R of the to-be-printed curved surface 1. The relationship between the principal curvature radius R1, R2 and the moving distance X of the center is determined based on a constant ratio k=X/R1,R2. The ratio k is preferably set at about 0.5.

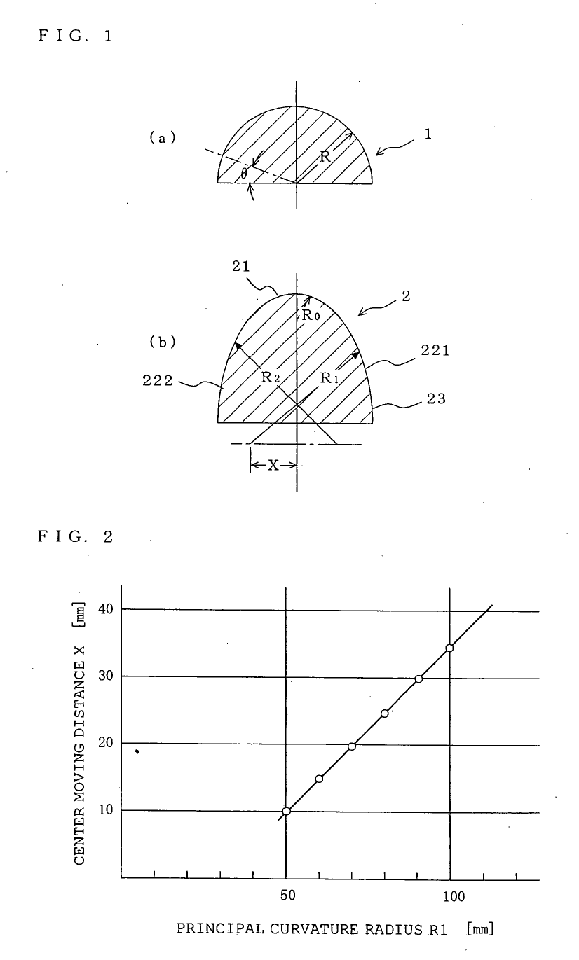

FIG. 2 is a graph showing an example of the relationship between the principal curvature radius R1, R2 and the moving distance X of the center.

FIG. 2 shows that preferably a proportional relation by a constant ratio is established between the principal curvature radius R1, R2 and the moving distance X of the center.

That is, an angle β between the principal curvature radius surface 221, 222 of the blanket 2 and a tangent in a position of half the circumference (90° from the vertex) of the to-be-printed curved surface 1 at the time when the blanket 2 is pushed down to the printing length corresponding to the position of half the largest circumference (90° from the vertex) of the to-be-printed curved surface is set to (60°±10°) as a condition for comparatively stabilized bending δ of the principal curvature surface of the pad caused by the pushing.

Silicone rubber is suitable for the material of the curved surface printing blanket 2. The silicone rubber is comparatively balanced among absorbability with which ink can be transferred from the letterpress original plate to the surface of the blanket 2, releasability with which the ink can be transferred perfectly to the to-be-printed curved surface 1, and a property with which the ink can be prevented from surviving in the surface of the blanket 2 after being printed on the to-be-printed curved surface 1.

The silicone rubber generally put into practical use has a material hardness (JIS A-scale) of about 20-90. As proved from many test results, the curved surface printing blanket 2 is desired to have a material hardness (JIS A-scale) of about 3-30, preferably to be comparatively soft and have a material hardness of about 3-20 in view of a displacement.

As described above, the surface shape of the curved surface printing blanket 2 changes in each of the step (A) of transferring ink from the letterpress original plate to the curved surface blanket 2 (wherein the surface of the blanket 2 displaces from a curved surface to a flat surface), the step (B) of moving the blanket 2 to the position of the to-be-printed body 1 (wherein the surface of the blanket 2 displaces from the flat surface to a curved surface) and the step (C) of pressing the blanket 2 onto the to-be-printed body 1 so as to perform printing on the curved surface (wherein the surface of the blanket 2 displaces from a positive-polarity curved surface to a negative-polarity curved surface).

Therefore, the accuracy to transfer an image in the step A which is an initial step is extremely important.

The present invention is characterized in that the proper height of a raised portion supplied with ink in the letterpress original plate is made as low as possible, so that the accuracy to transfer an image and hence the printing accuracy can be improved.

An intaglio original plate is usually used as an original plate in printing with a blanket. Based on common sense, the intaglio printing original plate has a sunken portion formed by an exposure and corrosion method. The depth of the sunken portion is at least about several tens of times as large as the coating thickness of a photosensitive agent. Ink is scraped from a raised portion of the intaglio original plate, and ink reserved in the sunken portion is transferred to the blanket. Therefore, in curved surface printing where the depth of the sunken portion is large so as to change the surface shape, the accuracy to transfer the ink deteriorates, and hence the printing accuracy deteriorates.

In contrast, a letterpress original plate has a comparatively low height so that the printing accuracy is improved suitably for printing on a curved surface.

Recently, the manufacturing accuracy of the raised portion of the letterpress original plate has been improved so that the height of the raised portion can be arranged to be lower. Accordingly, not only is it possible to reduce the ink viscosity to thereby reduce the ink film thickness, but it is also possible to use a small quantity of printing ink higher in density due to the reduced height of the raised portion. Thus, the printing accuracy has been improved remarkably.

In the invention, the letterpress printing original plate is a flat plate having a raised portion whose height is 0.1-50 μm. The height of the raised portion may be 20-50 μm if comparatively high printing accuracy is not requested. When high curved surface printing accuracy is requested, it is preferable that the height of the raised portion is made about 0.1-25 μm. When especially high accuracy is requested, it is preferable that the height of the raised portion is made about 0.1-3 μm.

In addition to the reduced height of the raised portion, the ink film thickness can be reduced. Thus, the printing accuracy can be improved remarkably.

The letterpress original plate which is a flat plate is usually made of an aluminum alloy plate, and has a raised portion formed out of a photosensitive agent.

A practical numerical measure of the proper height of the raised portion in the present invention is provided as height ½ to ⅓ as large as the thickness of the photosensitive agent in a usual letterpress printing original plate.

Not to say, it is important for the raised portion to have height necessary and sufficient to transfer ink to the curved surface printing blanket 2.

By use of a letterpress original plate having a raised portion having a height about ½ to ⅓ as high as the thickness of a photosensitive agent in a usual letterpress printing original plate, improved printing accuracy can be obtained even in the curved surface printing blanket 2.

The properties of printing ink to be used, particularly the viscosity thereof is extremely important to keep the printing accuracy in the present invention characterized in that the height of the raised portion of the letterpress printing original plate is reduced as described above.

As a result of many practical tests, it was proved that preferably the viscosity of printing ink is in a range of 5-500 PaS (at 25° C.) in conditions where the manufacturing accuracy of the raised portion of the letterpress original plate is improved so that the height of the raised portion can be reduced as described above. In addition, it is preferable that the viscosity is 15-250 PaS (at 25° C.) when the height of the raised portion of the letterpress printing original plate is 0.1-25 μm.

In the present invention, it is not preferable that the viscosity is lower than 5 PaS because stain other than an image appears in the letterpress original plate.

When the viscosity is higher than 500 PaS, it is difficult for the ink to spread on the surface of the curved surface printing blanket of silicone rubber. That is, the absorbability onto the blanket surface deteriorates. Further, when the height of the raised portion is not higher than 0.1 μm, sufficient printing accuracy cannot be kept no matter how the film thickness of the printing ink is reduced.

As for a practical measure of the viscosity of the printing ink in the present invention, the viscosity may be made about 1⅕ times as high as the viscosity of offset printing ink used in the same conditions in usual planographic-plate offset printing. In this case, the aforementioned conditions can be satisfied substantially.

According to the aforementioned embodiment, accurate printing on a curved surface can be obtained easily so that printing can be performed upon various kinds of to-be-printed curved surfaces.

The printing is suitable to-be-printed curved surface bodies including automobile parts, particularly exterior and interior members for cars, automobile handles, bodies of cellular phones, bodies of electrical household appliances, or sporting tools such as golf heads and shafts, fishing rods, various rackets, helmets, etc.

Due to the high printing accuracy, the printing can be applied to various kinds of ornaments, particularly eyeglass frames.

### EXAMPLES

### Example 1

### To-be-Printed Curved Surface Body Sample

D×L 30 mmφ×100 mm, polypropylene cylindrical material
printed on surface ranging over 180° of outer circumference

Curved Surface Printing Blanket:
R1,R2×L1(bottom breadth)×top r 90 mm×105 mm×15 mm
material silicon rubber, hardness (JIS A-scale) 15
surface roughness a (0.1-0.3 μm), b (0.5-2 μm), c (2.5-3.5 μm), d (5-10 μm), e (10-30 μm)

Ink Used:
UV-type ink

Letterpress Original Plate:
letterpress original plate made of Al
photosensitive agent raised portion height 1 μm
line width 0.5±0.02 mm
standard grid pattern of grid intervals 5±0.3 mm

Printing Machine:
horizontal displacement type three-stage blanket printing machine (SHUHO Model 3)

Curved surface printing blankets 2 different in surface roughness were produced. Printing with the blankets was performed on to-be-printed curved surface body samples by the aforementioned steps A to C. The state where the ink survived in the original plate was observed in the step A. The state of the ink transferred on the surface of each blanket 2 was observed in the step B. The state of printing on the surface of the to-be-printed curved surface body sample 1 and the state where the ink survived on the blanket surface were observed in the step C. Those states were observed by a microscope (power of 50×).

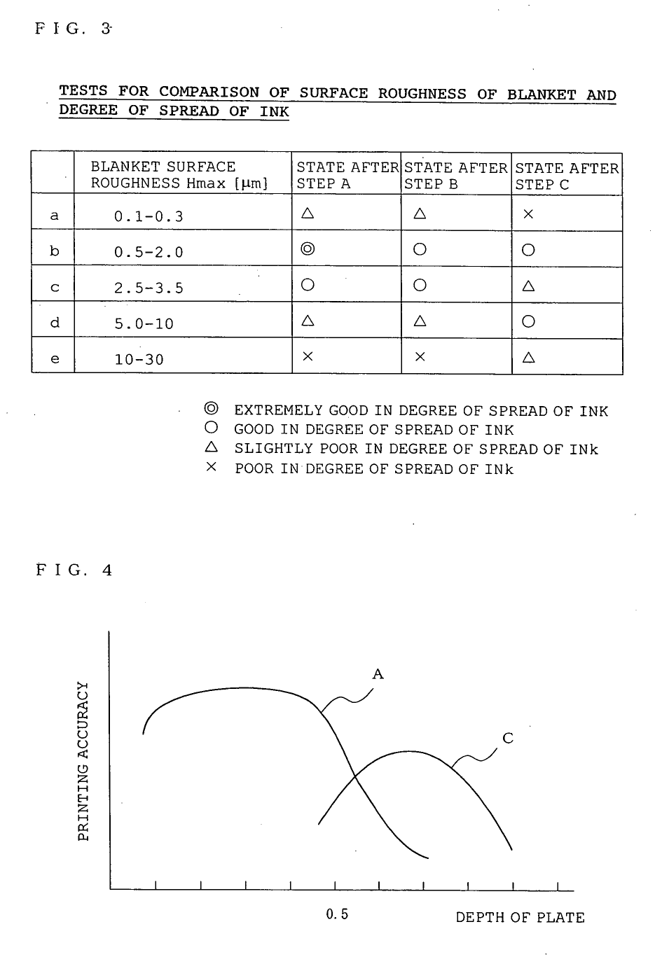

FIG. 3 is a table showing results of tests for comparison between the surface roughness of the curved surface printing blanket 2 according to the present invention and the degree of spread of printing ink.

From the results of the tests, it was proved that the degree of spread of ink is considerably affected by the surface roughness of the blanket 2. That is, the degree of spread of ink is not satisfactory when the surface of the blanket 2 is too fine or too rough, so that there is a proper range of surface roughness. Particularly when the surface of the blanket 2 is too rough, there is a possibility that ink cannot be transferred sufficiently from the letterpress original plate in the step A.

FIG. 4 is a graph showing results of testing the relationship between the height of a raised portion of a printing original plate (depth of a sunken portion in the curve C) and the printing accuracy. In FIG. 4, the X-axis designates the ratio of the height, where usual raised portion height (t1) in a background-art letterpress printing original plate was regarded as 1.

It was proved that in the case (A) of the present invention there was a peak of printing accuracy in height about ½ to ⅓ as large as the height (t1) in the background-art letterpress printing original plate, and good printing accuracy about twice as large as the accuracy in the case of an intaglio printing original plate (C) could be obtained.

### Example 2

### To-be-Printed Curved Surface Body Sample

D×L 30 mmφ×100 mm, polypropylene cylindrical material

printed on surface ranging over 180° of outer circumference

Curved Surface Printing Blanket:

R1,R2×L1(bottom breadth)×top r 90 mm×105 mm×15 mm

material silicon rubber
hardness (JIS A-scale) 5, 15, 30, 40, 50, 60
surface roughness 0.5-2 μm
   Ink Used:

UV-type ink

Letterpress Original Plate:

letterpress original plate made of Al

photosensitive agent raised portion height 1 μm

line width 0.5±0.02 mm

standard grid pattern of grid intervals 5±0.3 mm

Printing Machine:

horizontal displacement type three-stage blanket printing machine (SHUHO Model 3)

Printing accuracies were compared by changing only the hardness of silicon rubber while fixing the other conditions.

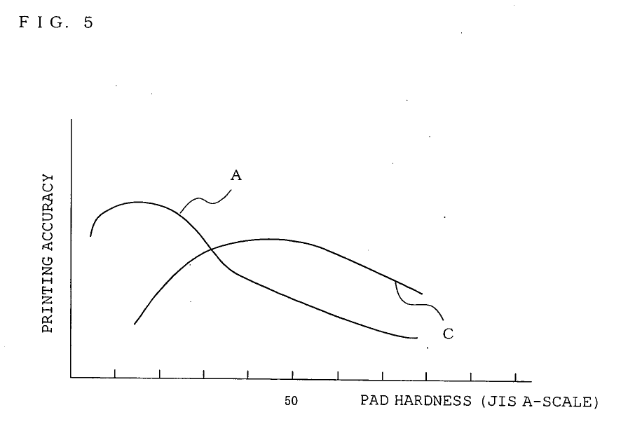

FIG. 5 is a graph showing results of testing the relationship between the blanket hardness H and the printing accuracy.

Silicone rubber usually has a hardness (JIS A-scale) of about 10-90. From the test results, however, it is desired that the curved surface printing blanket 2 has a hardness of 3-30, preferably about 3-20. When the hardness is high to be not lower than 40, the printing accuracy deteriorates extremely. On the contrary, when the hardness is not higher than 3, a printing process is not stabilized.

In addition, testing was performed in the condition that the hardness of the blanket 2 was changed in accordance with the size of the curvature radius of a to-be-printed body. As a result, there was obtained knowledge that preferably the hardness of the blanket 2 is changed according to a curvature radius of a to-be-printed body and made comparatively low for a large curvature radius.

### Example 3

### To-be-Printed Curved Surface Body Sample

D×d 400 mmφ×30 mmφ, polypropylene annular body

printed on one side (surface ranging over 180° of outer circumference d) divided into two in axial direction of annular body, twice (both sides)

Curved Surface Printing Blanket:

R1,R2×L1×top r×D 90 mm×105 mm×15 mm×400 mm

material silicon rubber
hardness (JIS A-scale) 15
surface roughness 0.5-2 μm
   ink used UV-type ink (color; brown, dark brown)
   Letterpress Original Plate:

letterpress original plate made of Al

photosensitive agent raised portion height 0.2 μm

two-color psychedelic waved discontinuous pattern

Real printing was performed twice on the upper and lower surfaces of an annular body. After the second printing, a slight shear of printing was recognized on a printing overlapped portion, particularly the inner diameter side of the annular body, but it was acceptable as a commercial product. Good whole surface printing could be obtained in general.

### Example 4

By use of a to-be-printed curved surface body where a semi-cylindrical curved surface body obtained by cutting the cylindrical portion of D×L=30 mmφ×100 mm in Example 1 at an arc angle was formed on a central portion of a flat to-be-printed surface (100 mm×100 mm), printing was performed on this flat portion by a flat surface pad system. After that, overprinting was performed on the curved surface body portion with the blanket in Example 1. In to-be-printed body samples, an angle θ between the flat to-be-printed surface and the tangent at a contact point between the flat to-be-printed surface and the flat surface of the semi-cylindrical curved surface body was set as 90°, 105°, 120° and 135°. The other conditions followed those in Example 1.

According to the results of printing, there was a wide variation of accuracy in the contact portion between the flat to-be-printed surface and the semi-cylindrical curved surface body. The sample whose angle θ was 90° was discouraging due to a non-printed portion appearing in a corner portion. In the samples whose angles θ were not smaller than 105°, normal printing was obtained in any corner portion. It is desired that the shape in the contact point between the flat to-be-printed surface and the curved surface body has an angle θ not smaller than 105°, preferably not smaller than 120°. Even when the angle θ is 90°, the non-printed portion can be avoided if a proper R-surface is provided in the contact corner portion. In this case, it is more preferable that the curvature radius r of the R-surface is made larger than the bending R of the blanket occurring in the corner portion.

### INDUSTRIAL APPLICABILITY

The present invention has been described about printing on a curved surface having a simple curvature radius in its Examples, but it is also applicable to printing not only on a simple curved surface but also on any complicated one if it is a curved surface.

### DESCRIPTION OF REFERENCE NUMERALS AND SIGNS

1 . . . to-be-printed curved surface body, 2 . . . blanket, 221 . . . curved surface with principal curvature radius R1 in the blanket, 222 . . . curved surface with principal curvature radius R1 in the blanket, 21 . . . portion rounded in portion where the curved surfaces with R1 and R2 meet each other, 23 . . . blanket base portion, R . . . sectional curvature radius of the to-be-printed curved surface, R1,R2 . . . principal curvature radius of the blanket, R0 . . . curvature radius of the portion rounded in portion where the curved surfaces with R1 and R2 meet each other, X . . . center moving distance (eccentric distance) of R1,R2, and θ . . . angle in contact portion.

1. A method of printing on a curved surface, characterized by comprising the steps of: applying printing ink to a raised portion of a letterpress printing original plate which is a flat plate having the raised portion 0.1-50 μm high in height; pressing a rubber or rubbery elastic blanket, which has a curved surface with a predetermined shape set correspondingly to a convex curved surface or a concave curved surface of a to-be-printed object so as to have the same polarity direction as the convex curved surface or the concave curved surface of the to-be-printed object, onto the letterpress printing original plate disposed at a fixed position and supplied with the printing ink, so as to transfer the printing ink to the predetermined-shape curved surface; and moving the elastic blanket having the predetermined-shape curved surface with the printing ink transferred thereto, and bringing the elastic blanket into contact onto the curved surface of the to-be-printed object so as to perform printing thereon.

2. The method of printing on a curved surface according to claim 1, characterized in that the height of the raised portion of the letterpress printing original plate is 0.1-25 μm.

3. The method of printing on a curved surface according to claim 1, characterized in that the height of the raised portion of the letterpress printing original plate is not smaller than 0.1 μm and smaller than 3 μm.

4. A method of printing on a curved surface, characterized by comprising the steps of: applying printing ink to a raised portion of a letterpress printing original plate which is a flat plate having a raised portion ½ to ⅓ as high as a thickness of a photosensitive agent in a usual letterpress printing original plate in view of practical measure; pressing a rubber or rubbery elastic blanket, which has a curved surface with a predetermined shape set correspondingly to a convex curved surface or a concave curved surface of a to-be-printed object so as to have the same polarity direction as the convex curved surface or the concave curved surface of the to-be-printed object, onto the letterpress printing original plate disposed at a fixed position and supplied with the printing ink, so as to transfer the printing ink to the predetermined-shape curved surface; and moving the elastic blanket having the predetermined-shape curved surface with the printing ink transferred thereto, and bringing the elastic blanket into contact onto the curved surface of the to-be-printed object so as to perform printing thereon.

5. The method of printing on a curved surface according to claim 1, characterized in that the convex curved surface or the concave curved surface of the to-be-printed object is a simple arc curved surface having a curvature radius R.

6. The method of printing on a curved surface according to claim 1, characterized in that a principal axis section of the predetermined-shape curved surface is composed of two principal curved surfaces and an end portion curved surface smoothly connecting a portion where the two principal curved surfaces cross each other; the two principal curved surfaces have curvature radii R1 and R2 composing the predetermined-shape curved surface correspondingly to a curvature radius R of the principal axis section of the curved surface of the to-be-printed object; the curvature radii R1 and R2 are 4-8 times as large as the curvature radius R, and a value with which distances L from centers of the curvature radii R1 and R2 cross each other is 2-4 times as large as the curvature radius R; and the end portion curved surface has a curvature radius equivalent to the curvature radius of the to-be-printed object.

7. The method of printing on a curved surface according to claim 1, characterized in that a material of the elastic blanket is silicone rubber, and hardness (JIS A-scale) thereof is 3-30.

8. The method of printing on a curved surface according to claim 1, characterized in that a material of the elastic blanket is silicone rubber, and hardness (JIS A-scale) thereof is 3-20.

9. The method of printing on a curved surface according to claim 1, characterized in that the printing ink has a viscosity of 5-500 PaS.

10. The method of printing on a curved surface according to claim 1, characterized in that the printing ink has a viscosity of 5-250 PaS.

11. The method of printing on a curved surface according to claim 1, characterized in that the printing ink has a viscosity 1⅕ times as high as a viscosity of a usual offset ink as practical measure.

12. The method of printing on a curved surface according to claim 1, characterized in that surface roughness of the elastic blanket is 0.5-2 μm in Hmax.

13. A method of printing on a curved surface, characterized in that the to-be-printed object has a shape including a partially convex curved surface portion or a partially concave curved surface portion in a flat portion; flat surface printing is applied to the flat portion by a usual printing method; and curved surface printing according to the method of printing on a curved surface according to claim 1 is further applied to the partially convex curved surface portion or the partially concave curved surface portion.

14. A printed curved surface body having a surface printed by the method of printing on a curved surface according to claim 1.

15. The printed curved surface body according to claim 14, characterized in that the printed curved surface body is an automobile part.

16. The printed curved surface body according to claim 14, characterized in that the printed curved surface body is a handle or an interior or exterior member for a car.

17. The printed curved surface body according to claim 14, characterized in that the printed curved surface body is a body of a cellular phone or an electrical household appliance.

18. The printed curved surface body according to claim 14, characterized in that the printed curved surface body is a sporting tool.

19. The printed curved surface body according to claim 14, characterized in that the printed curved surface body is an ornament.

20. The printed curved surface body according to claim 19, characterized in that the printed curved surface body is an eyeglass frame in the ornament.
